(19) United States
(12) Patent Application Publication
(10) Pub. No.: US 2007/0068792 A1
(43) Pub. Date: Mar. 29, 2007

(54) System and method for acetic acid dehydration

(76) Inventors: JiYoung Jang, Plano, TX (US); Kuang-Yeu Wu, Plano, TX (US)

Correspondence Address: SPENCER S. CHEN, 38 DOCKSIDE CIRCLE, REDWOOD CITY, CA, 94065-1770, US

(21) Appl. No.: 11/233,724

(22) Filed: Sep. 23, 2005

(51) Int. Cl. B01D 3/34

(52) U.S. Cl. 203/14; 202/168; 202/169; 202/170; 203/43; 203/16; 203/60

(57) ABSTRACT

Disclosed is a distillation system and method for recovering acetic acid from a feed stream containing acetic acid and water stream generated during terephthalic acid production. The invention includes a liquid-liquid extraction column and a dehydration distillation column utilizing azeotropic distillation or conventional to recover the acetic acid. The liquid-liquid extraction column is installed upstream from the dehydration distillation column. The liquid-liquid extraction column produces an extract of an extraction solvent and acetic acid which is sent to the dehydration distillation column to separate the extraction solvent and acetic acid. The dehydration distillation column may be used with or without a condenser system to recover the energy. The condenser system is a steam generator that condenses the vapor into a concentrated acetic acid stream while generating a low pressure steam. Any remaining acetic acid in water is sent to a waste water recycling facility.

### RELATED APPLICATIONS

The present invention is related to commonly assigned non-provisional U.S. patent application Ser. No. 10/075,577 entitled “System and Method for Acetic Acid Recovery During Terephthalic Acid Production”, filed Feb. 12, 2002, Pub. No. US 2003/0150706A1, the complete disclosure of which is incorporated herein by reference for all purposes.

### BACKGROUND OF THE INVENTION

The invention relates generally to chemical processes used in the distillation of industrial chemicals, and more particularly to distillation systems and methods for the recovery of acetic acid from water. The present invention is particularly suited for the recovery of acetic acid used in the production of terephthalic acid.

Terephthalic acid is useful is useful in a diverse variety of industrial applications and chemical processes. For example, terephthalic acid is starting material for producing polyesters including plastic and Dacron™ polyester used in textile and container production. Polyethylene terephthalate (PET) is a form of polyester or Mylar that is an extremely tough resin and useful in many industrial and consumer applications. Soft drink and water bottles are made from this resin in addition to plastic jars and clamshell packages used in consumer good transport and food distribution. Purified terephthalic acid (PTA) is a higher grade of terephthalic acid which is used for finer industrial applications.

Terephthalic acid is typically produced by a reaction of paraxylene with molecular oxygen in the presence of catalysts. During the production process, acetic acid is used as a solvent of terephthalic acid. The acetic acid becomes diluted in water during the oxidation in a reactor section of a terephthalic acid plant in the production cycle. A portion of the acetic acid and water stream is then sent to a dehydration unit to remove the water generated in the reactor for recycling or waste.

Three different approaches have been employed in the terephthalic acid plants to separate the acetic acid and water so that the acetic acid can be recycled back to the reactor while the water generated by the reaction is sent to the waste water treatment facility for safe processing. One approach is by convention distillation wherein the different boiling point of the components provides for the separation of acetic acid and water. In an azeotropic distillation approach, entrainers are used to form azeotropes with the acetic acid and water providing for a change in energy requirements for processing. Liquid-liquid extraction is a final approach for acetic acid and water separation during the terephthalic acid production.

Distillation has been widely used as a primary unit operation for acetic acid recovery from water. In such processes, one or more towers are utilized to process a number of streams of varying concentrations of acetic acid with the purpose of recovering it for further use in an oxidation step. The products from the distillation tower are a bottom stream of concentrated acetic acid and an overhead stream that ideally would be pure water to minimize the loss of the valuable acetic acid solvent. A more pure overhead water stream would also reduce the burden on downstream waste water treatment facilities thereby preventing accidental chemical spills.

However, the distillation of acetic acid and water is not very efficient due to the highly non-ideal vapor/liquid equilibrium characteristics of the acetic acid/water system. Conventional distillation systems require the use of high number of theoretical stages, i.e., actual trays, and a high reflux ratio, i.e., high energy consumption, to obtain reasonably low levels of acetic acid, typically in the range of 0.5-0.8 wt % in the overhead distilled water. The overhead waste water is subsequently processed to recover certain organic by-products, and then, sent to the waste water treatment facility where any remaining acetic acid will be neutralized and spent.

The use of conventional distillation, therefore, involves high investment cost because of the large dimensions of the required tower and column equipment and a high operating cost because of the high amounts of steam consumption involved. Furthermore, the traditional process scheme does not allow one to economically obtain a distillate completely free of acetic acid. This limitation, in turn, presents operating problems including costs associated with the operation resulting from the acetic acid losses, costs associated with the treatment of the acetic acid in the waste water, limitations of the capacity of the downstream waste water treating facility and environmental problems that are continually increasing because of the ever more rigorous standards for acceptable levels of emission to the environment.

There has been an effort to look for alternatives to minimize the high operating costs associated with the conventional distillation for the separation of acetic acid and water. Chemical processors and companies have resorted to azeotropic distillation involving the addition of selective alkyl acetate, such as the isobutyl acetate (IBA), normal butyl acetate (NBA), normal propyl acetate (NPA) etc., as an entrainer to the dehydration column. The entrainer forms a low boiling azeotrope with water and therefore improves the relative volatility of the separation between the acetic acid and the alkyl-acetate/water azeotrope. This reduces the energy or theoretical stage requirements for the same separation. Compared to the conventional distillation, an azeotropic distillation approach typically reduces the energy (i.e., steam) consumption by 20-40% to the acetic acid/water dehydration column while giving relatively low acetic acid concentration, 300-800 ppm, in the distillated water. The azeotropic distillation column is generally operated at ambient pressure in the terephthalic acid plants in all prior art systems.

Other methods used in terephthalic acid production includes the use of liquid-liquid extraction with special extractive agents to recover the acetic acid from the water streams to only contain 0.1 wt % acetic acid to 20% acetic acid. Some of the agents usually used are acetates, amines, ketones and phosphine oxides and mixtures thereof. These agents are used as solvents such that a solvent is chosen which will dissolve one component preferentially, allowing the other component to leave in distillate. Once the extraction step is completed, a complicated series of distillation steps are required to recover the acid and to recirculate the extractive agent back to the extraction stage.

In view of such energy waste from the use of traditional distillation systems, what is needed is a distillation system which is energy efficient and produces less waste and unwanted byproducts. The system should also recycle both energy and initial products in an environmentally friendly manner. The distillation system and process should also be easily modifiable to existing chemical process systems to enhance current and existing plants. Moreover, the recovery system should be easy to install without large capital expenditures.

For these reasons, it would be desirable for a distillation system for recovering acetic acid to use less energy, generate energy for other uses within the plant. The system should save raw chemicals and material, result in less acetic acid runoff in waste water and save money. Such systems and methods should also be applicable in a wide variety of chemical processes on a wide range of industrial chemicals. The system should also be simple and less expensive to manufacture while being compatible with conventional systems and processes.

### BRIEF SUMMARY OF THE INVENTION

A distillation system for recovering acetic acid from water during terephthalic acid production is disclosed comprising an extraction column, a dehydration distillation column and at least one input feed stream containing acetic acid and water. The extraction column is located upstream from the dehydration distillation column. The extraction column is a liquid-liquid extraction column.

The feed stream into the extraction column is combined with an extraction solvent. The extraction solvent is selected from a group of isobutyl acetate, normal butyl acetate, isobutyl propyl acetate and isobutyl acetate.

The top output feed stream is fed downstream to a dehydration distillation column. The dehydration distillation column may be conventional dehydration distillation column, an azeotropic dehydration distillation column or any other suitable distillation unit. If an azeotropic dehydration distillation column is used, the feed stream is combined with an entrainer. The entrainer is selected from a group of isobutyl acetate, normal butyl acetate, isopropyl acetate and normal propyl acetate. The entrainer forms an azeotrope to change the properties of the feed components to provide better conditions for separation. In one embodiment of the invention, the entrainer is the same chemical as the extraction solvent.

Additionally, the distillation system further comprises a decanter. The decanter condenses a top vapor output of the azeotropic dehydration distillation column. The decanter condenses the feed stream into a first liquid phase and a second liquid phase. The first liquid phase may be returned to the azeotropic dehydration column as the entrainer or fed downstream to an at least one downstream processing unit or returned to the extraction column as the extraction solvent. The second liquid phase may be fed downstream to a downstream processing unit to recover trace organics or a waste water treatment plant.

In one embodiment of the invention, the at least one downstream processing unit is a distillation column. A liquid phase is separated into waste water and an extraction solvent. The extraction solvent is returned to the extraction column to be reused as the extraction solvent.

The distillation system further comprises a condenser. The condenser is used to generate steam which can be used to produce energy for dehydration, power or other uses.

A distillation method for the production of terephthalic acid is also disclosed comprising feeding a feed stream to an upstream extraction column. The extraction column is a liquid-liquid extraction column. The feed stream is extracted the feed stream into a first output phase and a second output phase. The first output phase is fed downstream stream to a dehydration column. The second output phase is fed to a waste water treatment plant or other downstream distillation column.

The dehydration column is an azeotropic distillation column which dehydrates and separates the feed stream into a top vapor phase and a bottom liquid phase by an entrainer. The top or overhead vapor phase is condensed in a decanter to produce a chemical product which is recycled to the azeotropic distillation column to be used as the entrainer. The chemical product is processed into organics, acetic acid and water. The top vapor phase may also be fed down stream to a second distillation column to recover a chemical product for recycling to the extraction column to be used as the extraction solvent. The chemical for the extraction solvent is selected from the group of isobutyl acetate, normal butyl acetate, isopropyl acetate and normal propyl acetate.

These, and other, goals and embodiments of the invention will be better appreciated and understood when considered in conjunction with the following description and the accompanying drawings. It should be understood, however, that the following description, while indicating multiple embodiments of the invention and numerous specific details thereof, is given by way of illustration and not of limitation. Many changes and modifications may be made within the scope of the invention without departing from the spirit thereof, and the invention includes all such modifications.

### BRIEF DESCRIPTION OF THE DRAWINGS

FIG. 1 is a block diagram outlining various process units in a typical plant during terephthalic acid production.

FIG. 2 illustrates a flow diagram of an acetic acid dehydration system with a liquid-liquid extraction column installed upstream from the dehydration column in an azeotropic configuration.

FIG. 3 depicts a flow diagram of an acetic acid dehydration system using conventional distillation system for producing terephthalic acid with an upstream liquid-liquid extraction column and a steam generator;

### DESCRIPTION OF SPECIFIC EMBODIMENTS

The invention arose out of an observation that large amounts of energy are expended within the system during the production of terephthalic acid. In addition to the energy expenditures, minimal to no recycling was occurring where solvents such as acetic acid were not recovered and were sent to waste water treatment facilities, thereby increasing the energy requirements by requiring further processing outside the scope of the plant system.

Typically, industrial chemicals such as terephthalic acid are produced during multiple fractionation stages where heavier liquids are distilled with lighter vapors. A distillation column is used which comprises a cylindrical tower housing with multiple tower internals to promote the interaction between the vapor and liquid.

Conventional tower internals refers to trays, valves, downcomers, sieves and the like. Conventional distillation refers to a conventional distillation tower without the use of entrainers or solvents in the separation of the chemicals. Azeotropic distillation refers to a distillation tower and process utilizing an entrainer to separate the chemicals. An entrainer is a mass separation unit, chemical or compound used to break the azeotrope by forming a lower boiling azeotrope with one of components.

In a typical terephthalic acid production plant, multiple feed streams containing ac acetic acid, water and trace of organic compounds such as P-Xylene, Methyl Acetate, Methanol, etc. are normally fed to a dehydration column to separate the acetic acid from the water using azeotropic distillation process scheme. The concentrated acetic acid stream from the bottom of the dehydration column is recycled to the reaction section in other part of the terephthalic acid production plant for reuse. The water stream from an overhead distillate of the dehydration column, containing trace amount of acetic acid and organics (considered as “waste water”) are either sent directly to the waste water treating facility or to a downstream column to recover the organic components and the entrainer for reuse. The remaining distillate is then sent to the waste water treating facility or other processing units within the plant

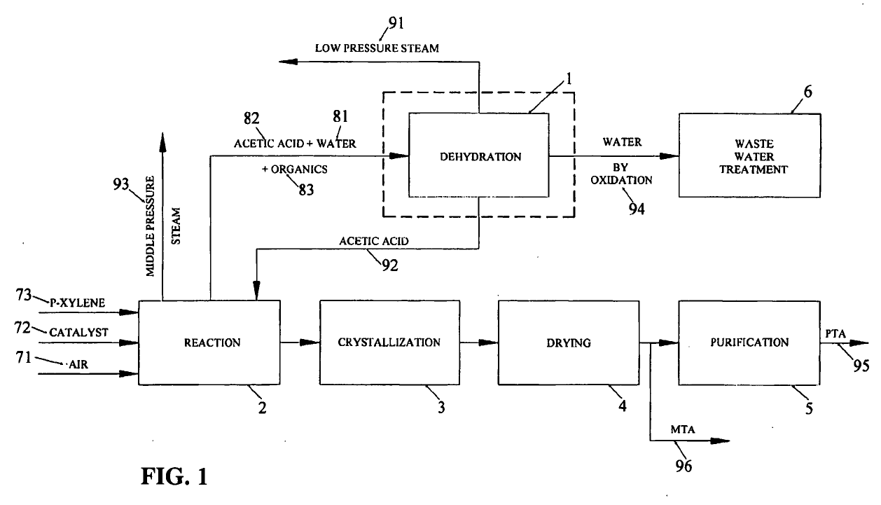

Turning now to the figures where like numerals depict similar components, FIG. 1 is a schematic block flow diagram of a typical terephthalic acid process plant. The major sections of the plant consist of reaction 2, crystallization 3, drying 4, purification 5, dehydration 1 sections or units. A waste water treatment facility 6 is typically the final component for processing in the terephthalic acid process plant.

The feedstock or inputs comprise paraxylene 73 and molecular oxygen (i.e., air 71) along with a catalyst 71. The feedstock is fed into the reaction section 2 or reactor. Terephthalic acid 95 is a product of the reactor. During the production of terephthalic acid, the product and water are produced according to the following chemical reaction:

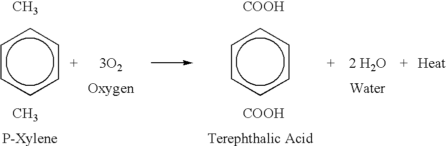

Terephthalic acid product is sent to crystallization 3, drying 4 and purification 5 units for further downstream processing to produce purified terephthalic acid 95 (PTA). The water 81 generated from the reaction and the solvent used in the reaction, i.e., the acetic acid 82, are sent to the dehydration section to recover the acetic acid 92 and return it to the reaction section for reuse. Middle grade terephthalic acid 96 (MTA) can also be produced and recovered before further purification into terephthalic acid 95 in the reaction. The water 94 is then sent to a waste water treatment facility for disposal.

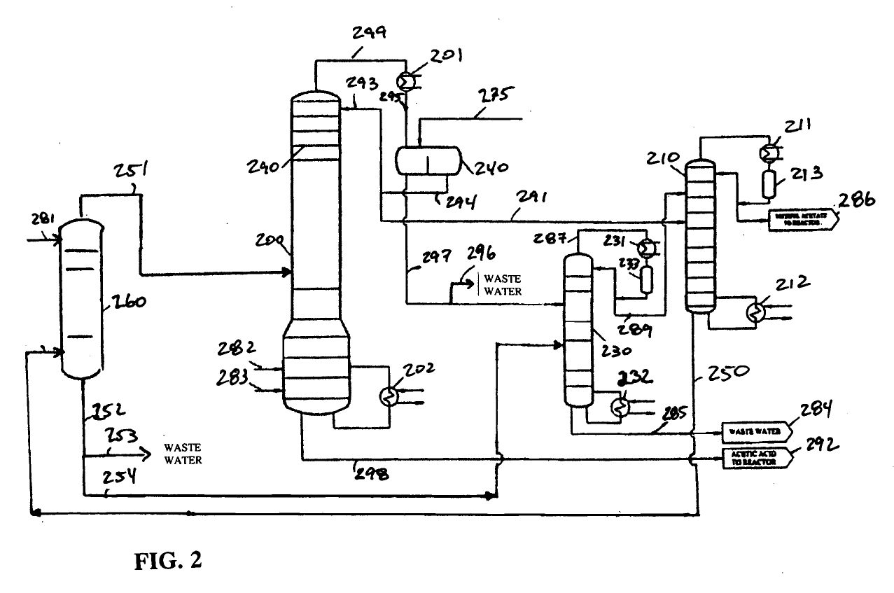

FIG. 2 illustrates a flow diagram using an azeotropic distillation system for acetic acid dehydration in the dehydration section of the terephthalic acid production plant. A liquid-liquid extraction column 260, or extractor, is installed upstream from a dehydration distillation column 200 in the system. At least one input feed stream 281 which was typically fed in to a dehydration column is now fed to the top of the liquid-liquid extraction column 260.

Within the liquid-liquid extraction column 260, input feed stream 281 is combined with an extraction solvent 250 and is used as a liquid-liquid extraction solvent to extract acetic acid from the waste water. The extraction solvent 250 is fed in to the bottom of extraction column 260 to extract the acetic acid from input feed stream 281.

In one embodiment of the invention, the extraction solvent 250 is comprised of a recycled component of downstream column 210. The extraction solvent 250 is selected from a group isobutyl acetate (IBA), normal butyl acetate (NBA), isopropyl acetate (IPA) and normal propyl acetate (NPA). Other chemicals may be used as extraction solvents which are known in the industry. In this embodiment of the invention, extraction solvent 250 is the same chemical as an entrainer used in the azeotropic distillation column 200.

The bottom product raffinate 252 from the extraction column 260 contains primarily water, trace amounts of organic compounds and the extraction solvent. Raffinate 252 is sent directly to a waste water treating facility 253 or can be sent as feed 254 to a downstream column 230.

Downstream column 230 is a distillation column. In this embodiment of the invention, column 230 is a stripper column. Column 230 has a condenser 231, a receiver or reflux drum 233 and a reboiler 232. Trace amounts of the organics, such as methyl acetate, entrainer and extraction solvent in feed 254 are separated in column 230. A bottom product 285 is sent to waste water treating facility 284 or other processing units. A top product 287 of column 230 is fed through condenser 231 and reflux drum 233 to produce a feed 289 containing trace amounts of methyl acetate and entrainer.

Feed 289 is sent to downstream column 210. In this embodiment of the invention, column 210 is a methyl acetate column. Methyl acetate column 210 is a distillation column with trays 290 to recover methyl acetate. Column 210 has a condenser 211, a receiver or reflux drum 213 and a reboiler 212. Methyl acetate 286 is recovered in the overhead and recycled to the reactor section.

A top product of the extraction column 260 or extract feed 251 containing a portion of the extraction solvent with the extracted acetic acid then exits the top of extraction column 260 and is fed to the azeotropic dehydration column 200. Additional feed streams 282 and 283 may also be added. The extract feed 251 is separated into acetic acid and the water in azeotropic dehydration distillation column 200 via an azeotropic process utilizing an entrainer. The entrainer is selected from a group isobutyl acetate (IBA), normal butyl acetate (NBA), isopropyl acetate (IPA) and normal propyl acetate (NPA). Other chemicals may be used as entrainers which are known in the industry.

Azeotropic dehydration distillation column 200 has a condenser 201 and a reboiler 202. Typically, azeotropic dehydration distillation column 200 consists of 60-90 distillation trays 290 operating at or near ambient pressure. Acetic acid 292, typically at 92-95 wt % of concentration is produced as a bottom product 298 of the azeotropic dehydration distillation column 200 and returned to the reaction section. The water, by forming a low-boiling azeotrope with the entrainer, along with trace amounts of unrecovered acetic acid and a small amount of reaction by-product, methyl acetate, exits the top of the column 200 as overhead vapor 299. An azeotrope is a mixture of pure components that has a constant boiling point and cannot be easily separated by conventional distillation. The boiling point of the azeotrope is lower than the boiling points of either of the two pure components.

From the overhead of the azeotropic dehydration distillation column 200, the vapor stream 299 can be sent through a typical water-cooled or air-cooled condenser 201. Condenser 201 may also include a steam generator to generate low pressure steam simultaneously (not shown). Vapor stream 299 is condensed in condenser 201 wherein the vapor stream mixture is cooled and condenses into 2 liquid phases. The resulting condensate 295, either from the steam generator or condenser, is sent to a condensate drum/decanter 240 for two liquid phase separations.

The resulting liquid condensate 295 formed from the overhead vapor 299 forms two phases, an organic phase and a water phase. The organic phase and acetic acid is combined with an entrainer such as IBA, NBA, IPA, or NPA from entrainer makeup 275 in decanter 240. A portion of the organic phase containing the entrainer and organic by-product with acetic acid is recycled back to the column 200 as reflux 293 to be reused as the entrainer.

The water phase 297 of decanter 240 is withdrawn from the condensate drum/decanter 240. Water phase 297 contains water, entrainer, methyl acetate that is dissolved in the water phase and a trace amount of acetic acid (typically 300-800 ppm). Water phase 297 is sent to waste water treating facility directly 296, or to a downstream column 230. The water phase of the decanter 240 containing is then fed to a downstream stripper column 230 to separate the methyl acetate and acetic acid.

Downstream column 230 recovers trace amounts of the organics, such as methyl acetate and remaining extraction solvent in output 287 and feed stream 289. Feed stream 289 is fed to downstream column 210 to recycle any remaining extraction solvent 250 to be used in extraction column 260. The remaining water 285 from downstream column 230 is sent to waste water treating facility or other processing units 284.

The organic phase 294 of decanter 240, primarily containing the extraction solvent(s) and small amount of organics, is withdrawn as output organic phase 294. In one embodiment of the invention, the output organic phase 294 contains the organic by-product, trace water, acetic acid and entrainer which may be fed directly to the extraction column 260 to be used as the extraction solvent. The extraction solvent is the same chemical as the entrainer used in the azeotropic dehydration distillation column 200.

In one embodiment of the invention, a portion of the organics is recycled to the azeotropic dehydration distillation column 200 as reflux 293 with the balance of the organic stream 291 being sent to downstream column 210. Light organic compounds, such as methyl acetate, are recovered from the overhead of the distillation column 210. Distillation column 210 separates the organic by-product, methyl acetate from the entrainer. Methyl acetate 286 recovered in the overhead is recycled to the reactor section.

Any remaining extraction solvent in organic stream 291 is separated as the bottom product 250 from the distillation column 210. Bottom product 250 containing primarily entrainer or extraction solvent chemicals, is then recycle back to the extraction column 260 for reuse as the extraction solvent.

There are two primary advantages of azeotropic distillation over conventional distillation, namely, 1) lower the energy (i.e. steam) consumption by 20-40% and 2) lower acetic acid loss to waste water treating facility from 0.5-0.8 wt % in the waste water. Comparatively, the acetic acid loss is typically 300-800 ppm with the azeotropic distillation versus 7000-7500 ppm for conventional distillation.

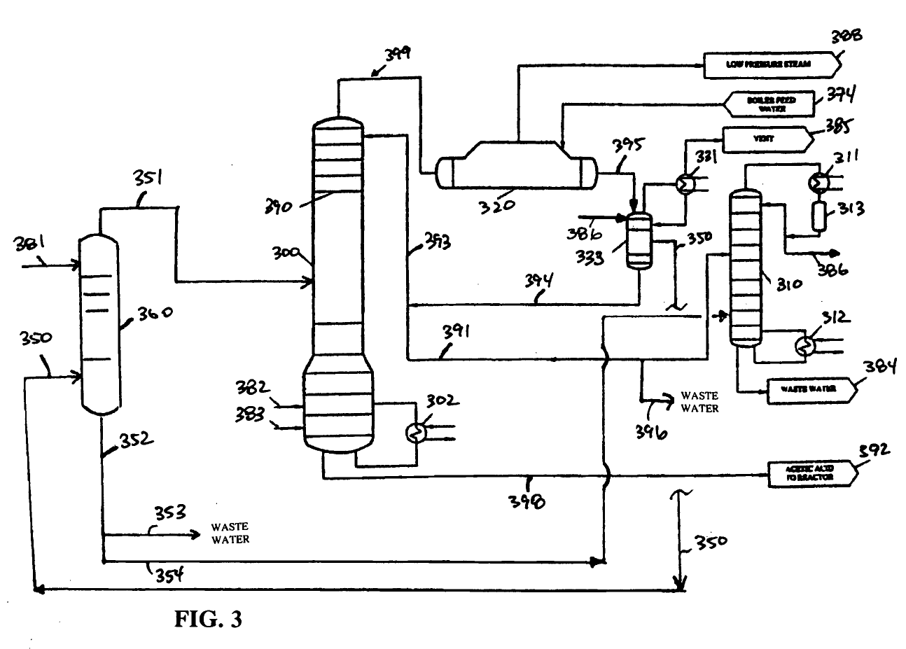

Turning now to FIG. 3, a conventional distillation system for the production of terephthalic acid utilizing a conventional dehydration distillation column or tower is depicted. Conventional dehydration distillation columns in terephthalic acid production plants are operated at ambient operating pressure.

A liquid-liquid extraction column 360, or extractor, is installed upstream from a dehydration distillation column 300 in the system. At least one input feed stream 381 which was typically fed in to a dehydration column is now fed to the top of the liquid-liquid extraction column 360.

Within the liquid-liquid extraction column 360, input feed stream 381 is combined with an extraction solvent 350 and is used as a liquid-liquid extraction solvent to extract acetic acid from the water. The extraction solvent 350 is fed in to the bottom of extraction column 360 to extract the acetic acid from input feed stream 381.

In one embodiment of the invention, the extraction solvent 350 is comprised of a recycled component of downstream column 310. The extraction solvent 350 is selected from a group isobutyl acetate (IBA), normal butyl acetate (NBA), isopropyl acetate (IPA) and normal propyl acetate (NPA). Other chemicals may be used as extraction solvents which are known in the industry.

The bottom product raffinate 352 from the extraction column 360 contains primarily water, trace amounts of organic compounds and the extraction solvent. Raffinate 352 is sent directly to a waste water treating facility 353 or can be sent as feed 354 to a downstream column 310.

In one embodiment of then invention, downstream column 310 is a methyl acetate column. Downstream column 310 is used to separate the organic by-product, methyl acetate 386 as the overhead product and the water and the acetic acid as the bottom product. Downstream column 310 has a condenser 311, a receiver or reflux drum 313 and a reboiler 312.

The bottom product containing any remaining acetic acid is then sent as water stream 384 to the waste water treatment facility for disposal or other processing units in the plant. The overhead output stream containing the methyl acetate 386 is fed back to decanter 333 for recycling.

A top product of the extraction column 360 or extract feed 351, containing the extraction solvent with the extracted acetic acid, then exits the top of extraction column 360 and is fed to the conventional dehydration distillation column 300. Additional feeds 382 and 383 may be fed into the distillation column 300. The extract feed 351 is separated into acetic acid and water via conventional distillation in a conventional dehydration distillation column 300.

Distillation column 300 typically includes trays 390 and a reboiler 302. Extract feed 351 is fed with acetic acid solvent 382 and a small amount of organic by-product, methyl acetate 383 into the conventional dehydration distillation column 300. Column 300 typically consists of 70-90 distillation trays 390. Bottom output 398 contains acetic acid 392, typically at 92-95 wt % concentration, and is recovered from the bottom of the column 300 and returned to the reaction section.

From the overhead of the conventional dehydration distillation column 300, the vapor stream 399 can be sent through an overhead condenser 320. Vapor stream 399 contains water, an organic by-product such as methyl acetate and any unrecovered acetic acid (typically 0.5-0.8 wt % in concentration). Vapor stream 399 exit the top of column 300 and is then condensed by overhead condenser 320 with boil feed water 374.

In this embodiment of the invention, overhead condenser 320 produces low pressure steam 388 simultaneously during condensation to recover some energy. The recycled energy may be used to power the plant or generate steam for boiling water or other uses. It will be appreciated that the steam generator may be removed from this system without departing from the spirit of the invention. Typically, a conventional dehydration distillation column generates low pressure steam (typically 0.6-0.7 kg/cm² g) at the top of the column.

The resulting condensate 395 from vapor stream 399 and overhead condenser 320 is sent to a condensate drum/decanter 333 for a two liquid phase separation into an organic phase and a water phase. A secondary condenser 331 further condenses the condensate with non-condensable vapor vented through vent 385. Any remaining extraction solvent in the organic phase is recovered at this point and recycled as extraction solvent 350 and fed back to extraction column 360 for reuse.

The water phase 394 is withdrawn from the bottom of the condensate drum/decanter, of which, a portion of the water is returned to the distillation column 300 as reflux 393. The balance of the water phase 391 is sent directly to waste water treating facility 396 or to a downstream column 310 to recover trace amount of the organics, such as methyl acetate 386, or sent to other processing units 384 within the plant.

Having generally described the invention, a further understanding can be obtained by reference to the following example, which is provided herein for purposes of illustration only, and are not intended to be limiting in any manner unless otherwise specified.

Example: In a typical 350,000 MTA terephthalic acid production plant, various acetic acid dehydration methods, namely, conventional distillation, azeotropic distillation at ambient operating pressure and the invention can be used. The typical design and operating benefits of the various methods can be summarized in the table below:

| | Conventional | Azeotropic | |
|---|---|---|---|
| | distillation | Distillation | Invention |
| Entrainer | No | Yes | Yes |
| Extraction | No | No | Yes |
| solvent | | | |
| No. of trays in | 90 | 90 | 90 |
| dehydration | | | |
| distillation | | | |
| column | | | |
| Steam | 60 | 42 | 36 |
| consumption in | | | |
| system (Ton/hr) | | | |
| Typical Acetic | 7000 | 500 | 800 |
| Acid conc. to | | | |
| Waste Water | | | |
| treating, ppm | | | |
| Waste Water | 13 | 13 | 13 |
| flow rate to | | | |
| WWT, Ton/hr | | | |
| Total Acetic | 728 | 52 | 83 |
| Acid loss to | | | |
| WWT, Ton/year | | | |

As illustrated in the table above, a distillation system for the dehydration of acetic acid using conventional dehydration distillation column with 90 fractionation trays requires the highest middle pressure steam consumption when compared to a system utilizing a typical azeotropic dehydration distillation column or an extraction column combined with an azeotropic dehydration distillation column as in one embodiment of the present invention. Additionally, the acetic acid loss in the conventional distillation system is substantially higher than that of the typical azeotropic distillation system or distillation system according to the present invention.

Comparatively speaking, the difference in acetic acid loss between the azeotropic distillation system and the distillation system in one embodiment of the present invention is negligible, e.g. less than 5%, when compared to the conventional distillation system. However, the total energy consumption of the present invention is much less. In terms of energy efficiency when compared to the conventional distillation system, there is a 30% savings in the azeotropic distillation system and a greater than 40% energy savings in the distillation system of the present invention. Further total energy savings may be gained by utilizing steam generation systems to recover energy from the heat generated from the distillation reactions.

As shown in one embodiment of the present invention, the total acetic acid loss remains low as in typical azeotropic distillation and in comparison to conventional distillation. The invention combines both the benefits of conventional distillation and azeotropic distillation in a novel way to provide substantial economical benefits over prior art systems and methods. Furthermore, the lower total energy consumption may provide for additional system total throughput of 10-15%. This additional throughput would result in a greater capacity for processing in the distillation system while still maintaining a total energy savings.

The energy savings plus the recovery of more raw materials in one embodiment of the present invention provides for more capital for improving system efficiency and better maintenance for the system. By reducing the number of chemicals needed for both the extraction solvent and the entrainer, a greater savings may be realized in reducing the time needed to introduce separate chemicals for each step, reduces the storage space needed for separate chemicals and saves in the cost of buying the separate chemicals. This savings could be realized in both new plant constructions and revamp projects.

Thus, in one embodiment of a terephthalic acid production plant, distillation system and method according to the present invention illustrates numerous differences over a conventional distillation method and typical azeotropic distillation schemes. Lower total energy and steam consumption is required in the present system. A higher acetic acid recovery from reaction water such that less acetic acid is lost to be processed at a waste water facility, resulting in less waste water pollution while conserving resources. Additionally, the dehydration of the acetic acid during the terephthalic acid production may generate a steam for power generation or other uses in the plant.

All publications and patent applications mentioned in this specification are herein incorporated by reference to the same extent as if each individual publication or patent application was specifically and individually indicated to be incorporated by reference.

While the invention has been described with respect to multiple embodiments, it will be appreciated that other alternative embodiments may be included. For example, with respect to all of the explicitly disclosed embodiments, as well as all other embodiments of the invention, a different distillation system including different tower internal designs and arrangements may be incorporated. Various other column modifications including multiple dehydration stages and extraction columns and uses of alternate entrainers may be utilized. These and various other modifications can be made to the disclosed embodiment without departing from the subject of the invention.

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. A distillation system for recovering acetic acid from water during terephthalic acid production comprising:
an extraction column;
a dehydration distillation column; and
at least one input feed stream containing organics, acetic acid and water.

2. The distillation system according to claim 1 wherein the extraction column is located upstream from the dehydration distillation column.

3. The distillation system according to claim 1 wherein the extraction column is a liquid-liquid extraction column.

4. The distillation system according to claim 1 wherein the extraction column utilizes an extraction solvent.

5. The distillation system according to claim 4 wherein the extraction solvent is selected from a group of isobutyl acetate, normal butyl acetate, isobutyl propyl acetate and isobutyl acetate.

6. The distillation system according to claim 1 wherein the dehydration distillation column is an azeotropic dehydration distillation column.

7. The distillation system according to claim 6 wherein the azeotropic dehydration distillation column utilizes an entrainer.

8. The distillation system according to claim 7 wherein the entrainer is selected from a group of isobutyl acetate, normal butyl acetate, isopropyl acetate and normal propyl acetate.

9. The distillation system according to claim 7 wherein the entrainer is the same as an extraction solvent used in the extraction column.

10. The distillation system according to claim 1 further comprising a decanter.

11. The distillation system according to claim 10 wherein a product of the decanter is returned to the extraction column as an extraction solvent.

12. The distillation system according to claim 1 further comprising at least one downstream processing unit.

13. The distillation system according to claim 13 wherein a product of the distillation column is returned to the extraction column as an extraction solvent.

14. The distillation system according to claim 1 further comprising a condenser to produce steam.

15. A distillation method for the production of terephthalic acid comprising:
feeding a feed stream to an extraction column;
extracting the feed stream;
feeding the feed stream to a dehydration distillation column;
dehydrating the feed stream; and
processing the feed stream into organics, acetic acid and water.

16. The distillation method according to claim 15 wherein the extraction column is a liquid-liquid extraction column.

17. The distillation method according to claim 15 where the dehydration distillation column is an azeotropic dehydration column.

18. The distillation method according to claim 16 further comprising recycling a chemical in the feed stream for use in said extracting and said dehydrating.

19. The distillation method according to claim 18 wherein said chemical selected from the group of isobutyl acetate, normal butyl acetate, isopropyl acetate and normal propyl acetate.

20. The distillation method according to claim 16 further comprising generating steam.
